(19) United States
(12) Patent Application Publication
(10) Pub. No.: US 2025/0156747 A1
(43) Pub. Date: May 15, 2025

(54) HIGH-FIDELITY PREDICTION WITH TRUST REGIONS

(71) Applicant: International Business Machines Corporation, Armonk, NY (US)

(72) Inventors: Dung Tien Phan, PLEASANTVILLE, NY (US); Ali Koc, WHITE PLAINS, NY (US); Jayant R. Kalagnanam, Briarcliff Manor, NY (US)

(21) Appl. No.: 18/508,416

(22) Filed: Nov. 14, 2023

(51) Int. Cl. G06N 20/00

(52) U.S. Cl. CPC G06N 20/00

(57) ABSTRACT

According to one embodiment, a method, computer system, and computer program product for making high-fidelity predictions with trust regions is provided. The embodiment may include identifying a data set. The embodiment may also include partitioning the data set into two or more clusters. The embodiment may further include creating two or more disjoint polytopic regions in a multi-dimensional space, wherein a cluster from the two or more disjoint polytopic regions corresponds to a trust region from the two or more polytopic regions. The embodiment may also include training a machine learning model based on the two or more disjoint polytopic regions. The embodiment may further include drawing a conclusion based on the trained machine learning model.

### BACKGROUND

The present invention relates generally to the field of computing, and more particularly to machine learning.

Machine learning is a computing paradigm that allows computers to achieve a variety of tasks that might be impractical to perform by other means. Machine learning often involves training models to recognize patterns in ways inspired by, or meant to simulate, human intelligence. By “learning” from existing data, machine learning models can draw conclusions about unknown information with varying degrees of accuracy. The new tasks that can be performed with a trained machine learning model can then be combined with traditional computational methods to solve problems no human or computer could solve alone, with computational efficiency.

### SUMMARY

According to one embodiment, a method, computer system, and computer program product for making high-fidelity predictions with trust regions is provided. The embodiment may include identifying a data set. The embodiment may also include partitioning the data set into two or more clusters. The embodiment may further include creating two or more disjoint polytopic regions in a multi-dimensional space, wherein a cluster from the two or more disjoint polytopic regions corresponds to a trust region from the two or more polytopic regions. The embodiment may also include training a machine learning model based on the two or more disjoint polytopic regions. The embodiment may further include drawing a conclusion based on the trained machine learning model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for training and prediction through trust regions.

FIG. 3 illustrates an exemplary graph of clusters grouped into separate regions.

FIG. 4 illustrates an exemplary decision tree with trusted and ambiguous outcomes.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to machine learning. The following described exemplary embodiments provide a system, method, and program product to, among other things, make predictions about unknown data using trust regions to group clusters. Therefore, the present embodiment has the capacity to improve the technical field of machine learning by providing a method to distinguish between trustworthy information in distinct clusters and ambiguous information outside the trustworthy clusters.

As previously described, machine learning is a computing paradigm that allows computers to achieve a variety of tasks that might be impractical to perform by other means. Machine learning often involves training models to recognize patterns in ways inspired by, or meant to simulate, human intelligence. By “learning” from existing data, machine learning models can draw conclusions about unknown information with varying degrees of accuracy. The new tasks that can be performed with a trained machine learning model can then be combined with traditional computational methods to solve problems no human or computer could solve alone, with computational efficiency.

Because machine learning models are trained using real-world data, the data is not always objective or distinct, but often ambiguous. This ambiguity can lead to confused results, missed predictions, bias, overfitting, and other failures by a machine learning algorithm. An ideal clustering of data may separate data into distinct classifications, distinguishing clusters with meaningful criteria. As such, it may be advantageous to develop a method for separating data into meaningful regions surrounding meaningful clusters and training a machine learning model based on the newly conceived data.

According to one embodiment, a region-based prediction program identifies a data set. The region-based prediction program then partitions the data set into clusters. The region-based prediction program then creates disjoint polytopic regions, at least one for each cluster, in an N-dimensional space wherein the data may be modeled. The region-based prediction program then trains a machine learning model based on the regions. Training the machine learning model may include use of linear programming methods, such as integer linear programming or mixed-integer linear programming. The region-based prediction program then draws a conclusion or makes a prediction using the trained machine learning model.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

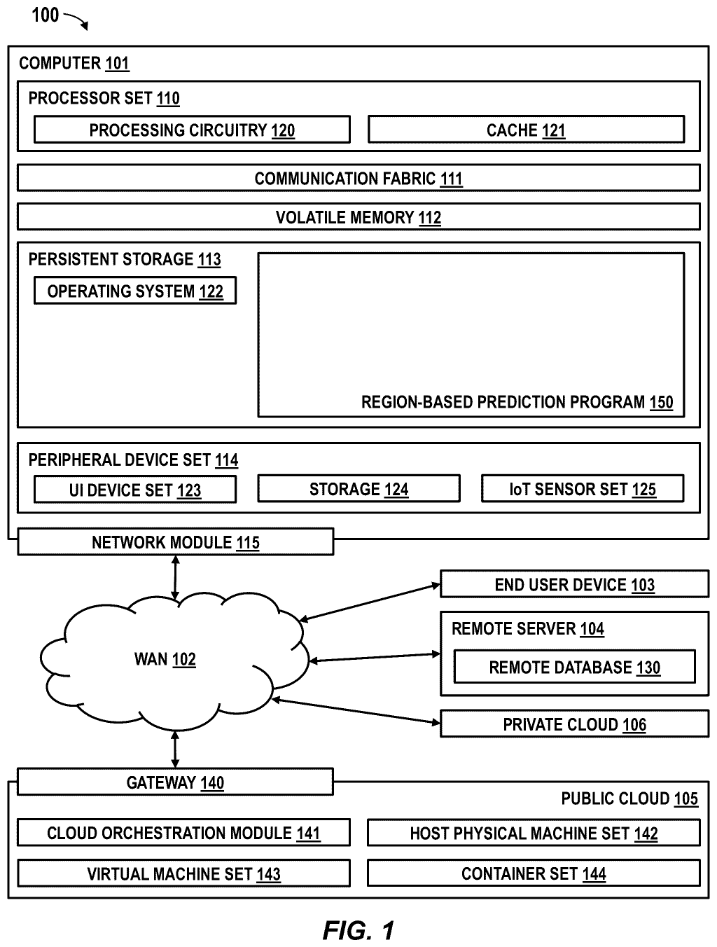

Referring now to FIG. 1, computing environment 100 contains an example of an environment for the execution of at least some of the computer code involved in performing the inventive methods, such as region-based prediction program 150. In addition to region-based prediction program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and region-based prediction program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventi ve methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in region-based prediction program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in region-based prediction program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The region-based prediction program 150 may identify a data set, and model the data set in an d-dimensional space. The region-based prediction program 150 may further partition the data set into clusters. The region-based prediction program 150 may then create a disjoint polytopic region corresponding to each cluster. The region-based prediction program 150 may then train a machine learning model using the regions. The region-based prediction program 150 may then draw a conclusion using the trained model.

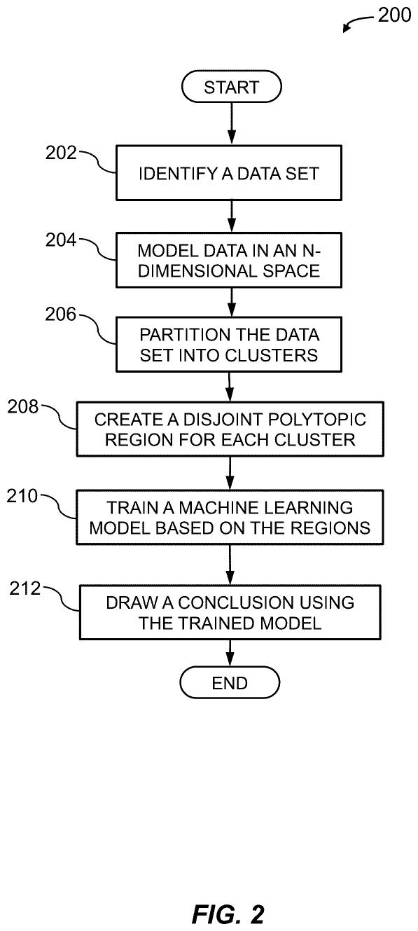

Furthermore, notwithstanding depiction in computer 101, region-based prediction program 150 may be stored in and/or executed by, individually or in any combination, end user device 103, remote server 104, public cloud 105, and private cloud 106. The data management method is explained in more detail below with respect to FIG. 2.

Referring now to FIG. 2, an operational flowchart for a process for making predictions based on trust regions 200 is depicted according to at least one embodiment. At 202, the region-based prediction program 150 identifies a data set. The data set may come from any source, and may exist in any format that may be conducive to mapping in d dimensions or otherwise assisting in the training of the machine learning model. Data may be identified continuously or regularly or otherwise over time, and at any point during the process for making predictions based on trust regions 200. The data set may be used as, thought of as, or translated into a form that can be used as training data for training the machine learning model at 210. Data may be obtained according to opt-in procedures.

A data set may feature, for example, a series of data points or items, each with a set of features or properties describing the data point or item. The region-based prediction program 150 may, at any point, identify a feature as a target feature. For example, if items in a data set represent video programming on a video streaming service, each item may be a movie, tv show, tv episode, or other piece of video content; each item may have features representing duration, budget, production time, genre, director name, or other features or properties, including scalar values. Target features may include critic ratings of the item, or a binary representation of whether or not the item wins a certain award.

A data set may be represented, for example, by a set of relations such as:

$$D = \{ ( {X}_{i} , {Y}_{i} ) ∀ i in the range ( 1 … N ) \vert {X}_{i} ∈ {ℝ}^{d} , {Y}_{i} ∈ \{ - 1 , 1 \} \}$$

Where D represents a data set, N represents the number of items in the data set, Xᵢ represents a vector or array describing each of the features of each element i in the data set, Yᵢ represents a simplified value of a target feature for each element i, [symbol] represents the real numbers, and d represents the number of features or dimensions the data set represents. For a training data set, Y may be limited to certain integer values, such as −1 and 1, representing known values of Y which therefore have no ambiguity. Values of Y between −1 and 1 may represent ambiguity. Y may have a simple binary domain or a larger domain.

In at least one embodiment, new data points in the data set may be identified over time, through any other step, or may be updated, modified, or corrected upon the identification of new data.

Then, at 204, the region-based prediction program 150 models the data set in a multi-dimensional space. The number of dimensions may be represented, for example, by a variable d, and the space may contain hyperplanes and polytopes. The region-based prediction program 150 need not prepare an actual physical or spatial representation of the multi-dimensional space, but may include formatting or processing data to identify data points that may be conceptualized in a multi-dimensional space for the purposes of partitioning into clusters or creating polytopic regions.

In at least one embodiment, in an d-dimensional space, a hyperplane may be an d−1 dimensional space, such as a shape or side of an d-dimensional shape, and a polytope may be an d-dimensional space, for example whose sides are represented by hyperplanes. A polytope may proceed infinitely in any dimension or direction; a polytope need not be enclosed on all sides, and may also proceed infinitely in any dimension or direction. In a two-dimensional space, a hyperplane may be a line, ray, or line segment, including a side of a polygon, and a polytope may be a polygon or other two-dimensional space delineated by lines, rays, or line segments. In a three-dimensional space, a hyperplane may be, for example, a plane, or a polygon, including a face of a polyhedron, and a polytope may be, for example, a polyhedron or other three-dimensional space. d may be any number, but the region-based prediction program 150 may have an objective of keeping the number of features used to define a hyperplane relatively low, or as low as possible, which may be beneficial to interpretability.

In some embodiments, modeling or mapping the data may include determining positions or values that represent identified data in the multi-dimensional space, or representing identified data in an actual visual, physical, or spatial representation of the multi-dimensional space.

In other embodiments, modeling or mapping data may include formatting or processing data to identify data points that may be conceptualized in a multi-dimensional space for the purposes of partitioning into clusters or creating polytopic regions, or fit a data format to be useful at steps 206, 208, and 210. Modeling or mapping data may include determining which features are most relevant to a mapping or translating features into a format that may be more relevant or useful.

For example, data describing A different features of B different vehicles may be represented as B data points, where each data point is a vector or array X describing each of the A features of each vehicle, may be conceived as a series of points in an A-dimensional space. Mapping data may include identifying features with scalar values, or converting non-scalar values into scalar values, or into scalar values more useful for mapping in a three-dimensional space (such that nearby values are meaningfully similar, and far-apart values are meaningfully distinct). For example, if a vehicle's properties include a word describing the color of the vehicle, the word may be converted to a hexadecimal value representing the color, to several different hexadecimal values representing different aspects of the color, or to a value representing how dark, bright, reflective, or prone to showing dirt stains the vehicle may be.

Similarly, target features may be translated into a format more conducive to the process for making predictions based on trust regions 200. For example, a scalar value or other value may be turned into a simplified, integer, or binary value. For example, if a feature represents an average critic's rating for the item, a target feature may be simplified to a 1 if the item's rating exceeds 70/100, or a 0 or −1 representing the case where the item's rating is less than or equal to 70/100.

The region-based prediction program 150 may map a data set to multiple multi-dimensional spaces, may map multiple data sets to one multi-dimensional space, may prepare multiple mappings of the same multi-dimensional space or may otherwise represent any number of data points in any number of spaces as may be conducive to the process for making predictions based on trust regions 200.

Next, at 206, the region-based prediction program 150 partitions the data set into two or more clusters. Clusters may be subsets of data that are related by close proximity in one or more dimensions. Clusters may be determined based on proximity of data points, density of data points in a given area, matching of a target feature, or other optimization factors, such as compactness, class purity, interpretability, or cheapness to check membership. Each cluster may correspond to a region at 208.

In at least one embodiment, clusters may be subsets of data that are related by close proximity in one or more dimensions. Proximity may represent similarity in one or more values along those dimensions. Proximity may be measured from each point to the nearest point, the average distance between an otherwise distinguished subset of data points, a measure of density of data points in an area, or any similar determination. Proximity may be determined based on other factors of similarity, and may account for other factors and outliers that are meaningfully connected to other points in the cluster.

In at least one embodiment, determining a cluster may include matching values of target features. For example, two proximate data points may be separated into two different clusters if one represents a target value that exceeds a threshold and the other represents a target value that falls short of the threshold.

Determining a cluster may include taking into account other optimization factors, such as compactness, class purity, interpretability, or cheapness to check membership. For example, an objective of the region-based prediction program 150 may be to identify clusters with compactness, such that there are few clusters or trust regions needed to describe the data, or high class purity, so that each cluster of proximate data reflects the same target value, and does not contain data that reflects a differing target value.

Upon failing to create clusters that meet the desired criteria or factors, the region-based prediction program 150 may return to 202 to collect or identify more data, or return to 204 to reformat data into a new mapping, select new relevant features, or otherwise the mapping to assist in creating a distinct, compact, class-pure, or meaningful set of clusters, or serve any other objective for the clustering.

A cluster may, but need not reflect proximity in all dimensions. For example, determining proximity may include determining that a particular cluster describing vehicles with a target feature of ultimate safety ratings is properly interpreted by proximity in features representing cost to manufacture; amount spent on body materials; amount spent on crash safety tests, but does not include amount spent on marketing or a scalar value representing color or shade of the vehicle; a different model may be similar, but may not factor in amount spent on body materials. Different clusters need not use the same dimensions, or the same number of dimensions. If no clusters take color into account, color may be excluded as a dimension in the mapping of the data at 204.

Determining clusters may be described, in terms of the relations presented at 202, as creating P clusters C₁ . . . C_{P}, where cluster Cⱼ is the set of points belonging to cluster j; requiring that a cluster be pure according to the cluster label Y_{C}_{ⱼ}, requiring that target value Yᵢ for all or for a majority elements i of cluster Cⱼ are equal to Y_{C}_{ⱼ}; or measuring the purity or accuracy of a cluster as a ratio of the number elements i of cluster Cⱼ with Yᵢ=Y_{C}_{ⱼ} to the overall number of elements in cluster Cⱼ.

For example, if cluster C₃ contains four elements with Y values Y₁=1, Y₂=0, Y₃=1, and Y₄=1, Y_{C}_{₃} may be 1, since that is the majority Y value of elements of C₃, and the accuracy of, purity of, confidence in, or trust in C₃ may be measured as 0.75, since three of the four elements match the cluster's label Y_{C}_{₃}. Confidence or trust may also be calculated or defined based on a complex equation weighing purity of the cluster alongside other confidence factors, such as confidence in the underlying data or in another process, such as the process used to define proximity.

In further embodiments, a cluster may further be described in terms of the minimal polytope enclosing each cluster so as to minimize the d-dimensional internal space of the cluster, such as the area of a 2-dimensional polytope or the volume of a 3-dimensional polytope. A density of the cluster may be calculated as the number of data points in the cluster divided by the d-dimensional internal space of the cluster.

Defining clusters may further include a process involving the linear programming methods or other aspects of the training method described at 210.

Then, at 208, the region-based prediction program 150 creates a disjoint polytopic region corresponding to each cluster, or to sets of clusters. The region-based prediction program 150 may further identify polytopic regions not corresponding to a cluster. Creating disjoint polytopic regions may be described as partitioning the d-dimensional space into disjoint regions. The polytopic regions may be defined based on one or more hyperplanes. Regions may include “trust regions,” “low confidence” regions, or “no support” regions.

The polytopic regions may be defined based on one or more hyperplanes. A hyperplane may be represented by a vector, array, expression, or equation describing the position of the hyperplane in the d-dimensional mapping, where the hyperplane has d−1 dimensions. The hyperplanes may be determined so as to draw a border or polytope around a cluster, or to separate one type of region from another type of region.

The hyperplanes and regions may be defined according to various criteria. For example, a region may be defined to fully enclose a cluster (identified by the set of elements of the cluster or a minimal polytope drawn at 206) or set of clusters, or to enclose a certain proportion of points in a cluster or set of clusters, or a maximal or weighted-maximal amount given other criteria. Alternatively, a region may be defined to use a minimal number of hyperplanes, as may be defined by a strict ceiling on the number of hyperplanes allowed, a soft target limit for the number hyperplanes allowed, a function of weighted factors to reduce the number of hyperplanes. Similarly, regions may be defined to minimize the overall number of polytopes, such as by drawing polytopes around a larger set of adjacent clusters as opposed to individual clusters. Other factors may include proximity of different clusters or data points; density of a cluster, set of clusters, or region; or rules to require enclosed polytopes, to maximize purity of a region according to the purity concepts described at 206, to reduce or minimize the number of dimensions to describe the hyperplanes, or to otherwise simplify the polytope.

A set of clusters may be defined, in addition to the above factors, to be completely pure across the label Y (either as applies to points or clusters in the set of clusters), to maximize purity across the label Y, to meet a minimum purity for the label Y, or to factor in purity over the label Y as a weighted factor. Alternatively, a set of clusters may be defined based on similarity in the level of purity among different clusters. For example, a set of three clusters may all have above 80% purity; another set of clusters, including three clusters with below 63% purity, may be defined to exclude an additional cluster that has 79% purity, despite proximity and a similar label. The region-based prediction program 150 may assign a label to, and calculate purity, trust, density, or any other factor for, any region.

Hyperplanes may be defined to meet criteria like the above criteria by any function, including an imperative function like a regression function or optimization function, or a process of artificial intelligence to optimize for certain factors or results, such as a machine learning model trained on data of regions partitioned by regression functions, by optimization of different factors above, or by human users. Alternatively, hyperplanes may be defined by a human user utilizing one or more functions or otherwise maximizing for factors described above. Defining hyperplanes or regions may further involve the training method described at 210, including calculations using linear programming methods.

The region-based prediction program 150 may further identify additional polytopic regions not corresponding to a cluster, such as low-confidence regions or regions with no support. Regions may be broken down into types, such as “trust regions,” “low confidence” regions, or “no support” regions. A trust region or region with high confidence may strongly correspond to a cluster, ideally to a cluster with high class purity, such that membership in the trust region strongly indicates a particular value of a target property. A low confidence region may be a region with sparse or ambiguous data, such as proximate data points that differ in the target value; for example, if the target value is likelihood of a movie to win an award, a low confidence region may be a region with some proximate data points that do and do not represent movies that won the desired award. A region with no support may be a region with either no data at all, or insufficient data to draw even ambiguous conclusions.

In alternate embodiments, the region-based prediction program 150 may subdivide or partition the d-dimensional space into more than three types of regions, such as eight different levels of regions based on degrees or measures of purity of the regions, confidence, trust, or support.

Additional regions may be defined using any of the methods described above, or to fill the space between trust regions. For example, in a two dimensional space, if one trust region is defined by the polytope formed above the hyperplanes described by y=x+2 and y=−x−2, and another trust region is defined by the polytope formed below the hyperplane described by y=−3, one or more additional regions may be defined, in whole or in part, by the space bounded by those three hyperplanes, thus not contained in any trust region. Alternatively, a low confidence region may be defined around, for example, a cluster with low class purity or low confidence in the label Y.

A more complex hyperplane may be described by an expression such as:

$${w}_{t}^{T} {X}_{i} + {B}_{t} \leq 0 , ∀ {X}_{i} ∈ C$$

where wₜ is a non-zero coefficient, t is an index of a decision tree node, T is a transpose operator meant to facilitate the multiplication of wₜ with Xᵢ, and Xᵢ represents a data point in cluster C. wₜ^{T} may, therefore, represent a vector of the same size as Xᵢ, containing at least one non-zero coefficient wₜ.

In further embodiments, a linear programming method, including an Integer Linear programming (“ILP”) or mixed-integer linear programming (“MILP”) method, may be additionally used to determine values of wₜ^{T} or Bₜ, for example by testing values and checking to see if known data can be satisfied by the test values using a linear programming feasibility method.

In an embodiment where values of a target property Y are simplified to 1 and 0 to indicate whether a given piece of test data does or does not have a property, a low-trust or ambiguous region may correspond to ambiguity, where new data points may be considered to have a decimal value of property Y between 0 and 1, such as either 0.5 to indicate ambiguity generally, or a more granular representation of probability or confidence in a system with many levels of trust regions.

In alternate embodiments, the region-based prediction program 150 may, in addition to disjoint trust regions, identify other regions that overlap or intersect for other purposes.

The hyperplanes and regions may be defined and re-defined over time, at any point, or in response to any event. For example, upon identifying a new data point at 202 or associating a data point with a new cluster at 206, the region-based prediction program 150 may assess nearby hyperplanes to determine if one of the hyperplanes needs to be modified.

Then, at 210, the region-based prediction program 150 trains a machine learning model using the regions. The machine learning model may additionally use the identified data, as identified or modified or formatted during any other step, or data describing the clusters. Training the model may include using linear programming methods, including ILP or MILP. Training the machine learning model may also include optimizing for weights relating to target feature Y, or for any other property from the data set.

The machine learning model may be trained using the regions, including data or expressions defining or describing the hyperplanes and polytopes, as well as the identified data, as identified or modified or formatted during any other step, or data describing the clusters.

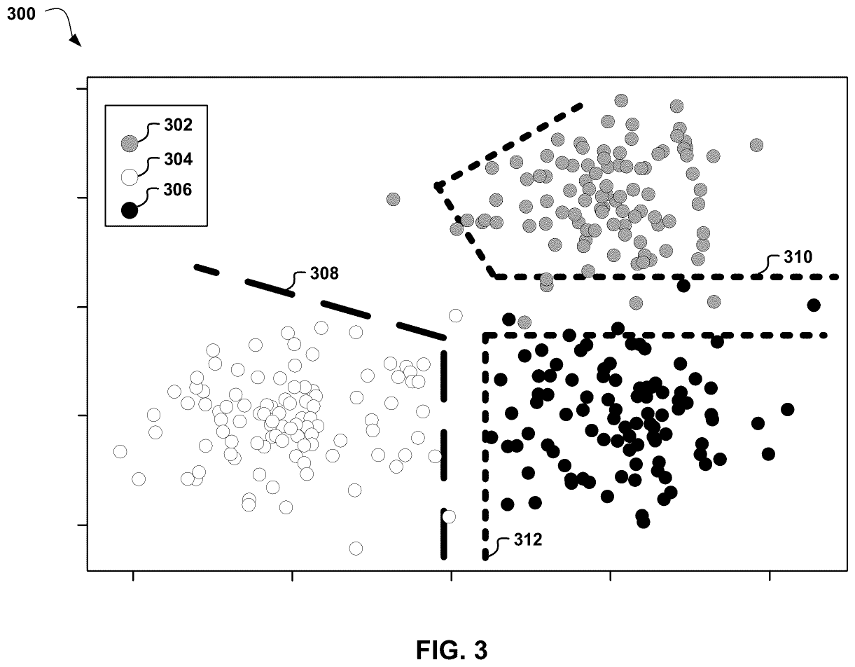

Training the model may include using linear programming methods, including integer linear programming or mixed-integer linear programming. More specifically, training the machine learning model may include following the logic of a decision tree, such as the decision tree at FIG. 3, or optimizing, using linear programming methods, any other factor, but particularly factors relating to the target feature Y. For example, cost weights may be determined as 1 for points placed in an incorrect region, 0.5 for points placed in an ambiguous region, or 0 for points placed in the correct region. Linear programming methods and optimization functions may also be used to determine optimal clustering at 206 or to assist in determining regions at 208.

Linear programming methods may include known methods, including ILP and MILP, that involve questions of feasibility or optimization of an objective function or variable based on a set of constraints. A preferred embodiment may utilize MILP.

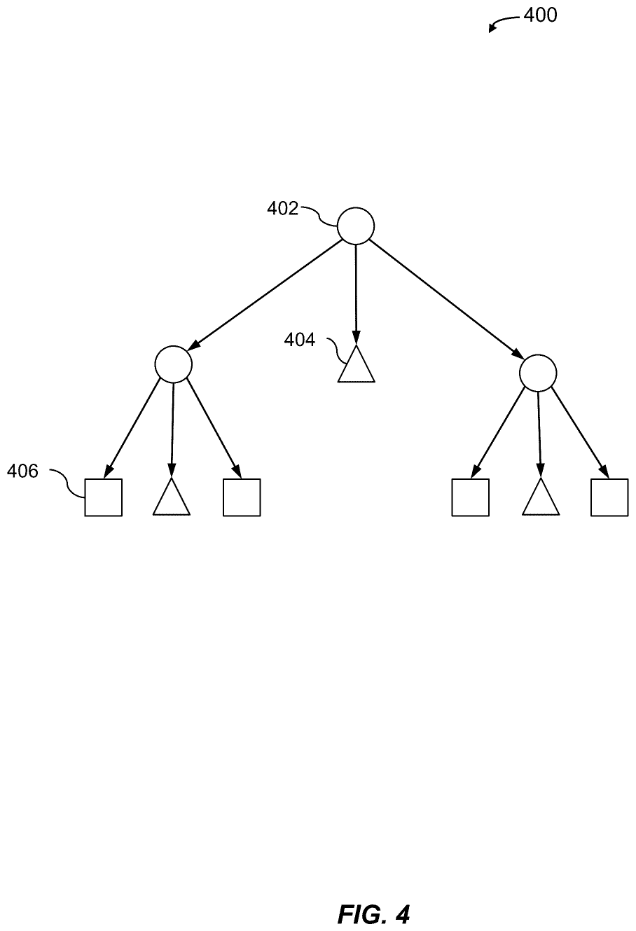

The machine learning model may be trained using linear programming functions or other optimization functions based on the regions, or particularly based on the hyperplanes that enclose the regions. For example, training using linear programming may identify constraints based on hyperplanes with coefficients w and additional constants B, sets of bounds l and r, or sets of values x and y. A more specific example of a training method using such values is provided at FIG. 4.

The model may be trained and re-trained over time, and may be trained simultaneously to the determining at 206 and the creating at 208.

Training the model may, in further embodiments, include the use of other known methods for training machine learning models. For example, a model trained using an above method may be refined based on feedback collected at 212.

Then, at 212, the region-based prediction program 150 draws a conclusion using the trained machine learning model. A conclusion may, for example, be a prediction about whether a new data point has or does not have a target feature, or of the value of a target feature, and may account for ambiguity or uncertainty as embodied by the training of the model. Alternatively, drawing a conclusion may include responding to a question or request about any unknown piece of data with which the trained model may be of assistance.

In further embodiments, the region-based prediction program 150 may collect feedback about the drawn conclusion. For example, if the conclusion is a prediction that a particular movie will not win an award, and the movie does win the award, the new data may be re-identified as a data point at 202, re-mapped at 204, and used to re-train the model at 210; or may be used directly as feedback for the model at 210 using any other method.

Referring now to FIG. 3, an exemplary chart 300 showing a mapping of data and partitioning of a two-dimensional space into three trust regions is depicted according to at least one embodiment. The chart may identify data points 302, 304, and 306. One-dimensional hyperplanes 308, 310, and 312 in the two-dimensional space may be rays or line segments, each forming a side of a respective two-dimensional polygon. In other embodiments, an d-dimensional space may contain d-dimensional polytopes formed from (d−1)-dimensional hyperplanes, for any N in the counting numbers.

Data points 302 may represent one cluster, mostly enclosed by the polygon formed with side 310. Data points 304 may represent one cluster, mostly enclosed by the polygon formed with side 308. Data points 302 may represent one cluster, mostly enclosed by the polygon formed with side 312.

Hyperplane 310 may be parallel to a x-axis, and hyperplane 312 may be parallel to a y-axis. This may be reflected by a single nonzero coefficient w in a vector wₜ^{T} in an expression describing hyperplane 310 or hyperplane 312. Hyperplane 308 may exhibit slope or change over two dimensions. This may be reflected by two nonzero coefficients w in a vector wₜ^{T} in an expression describing hyperplane 308.

Referring now to FIG. 4, an exemplary decision tree 400 is depicted according to at least one embodiment. A decision tree may be used to assist in the training of a machine learning model at 210, such as by determining constraints, weights of data points, or placement for a data point for a linear programming function or other optimization function.

Nodes of a decision tree may include branch nodes 402, which may also be referred to as burst nodes or decision nodes, from which a branching path extends to a lower node based on a decision, and leaf nodes, such as confusion leaf nodes 404, which may represent ambiguous or low-confidence regions in the d-dimensional space, or confident leaf nodes 406, which may represent a confident label or weight or a trust region in the d-dimensional space. Leaf nodes may be assigned a weight or value based on the type of leaf node or the region in which they are placed.

A branch node 402 with index t may be used to determine that training a machine learning model should follow one of its several branches based on several constraints and bounds. For example, if the top branch node 402 has index t=1, the constraints may be signified, for example, by, for the left branch node:

$${w}_{1}^{T} {X}_{i} + {B}_{1} \leq {L}_{1}$$

for the center branch:

$${L}_{1} < {w}_{1}^{T} {X}_{i} + {B}_{1} < {R}_{1}$$

and for the right branch:

$${w}_{1}^{T} {X}_{i} + {B}_{1} \leq {R}_{1}$$

Where w₁^{T}Xᵢ+B₁ describes a hyperplane relative to data point corresponding to branch node 1 as described at 208, L₁ signifies a left bound corresponding to branch node 1, and R₁ signifies a right bound corresponding to branch node 1. Each branch may describe placement of a data point Xᵢ relative to the described hyperplane.

Upon arriving at a leaf node 404 or 406, the region-based prediction program 150 may assign a weight corresponding to data point Xᵢ. For example, a confusion leaf node 404 may be assigned a weight of 0.5; a confident leaf node 406 may be assigned a weight of 1 if it corresponds to a trust region with a desired value of target label Y, or may be assigned a weight of 0 if it corresponds to a trust region with an undesired value of target label Y.

The decision tree 400 may have a depth of 3, signifying the distance between root node 402 and the lowest leaf nodes, such as confident leaf node 406, inclusive. Alternatively, the decision tree may have any arbitrarily high depth.

In further embodiments, a linear programming method, including an ILP or MILP method, may be additionally used to determine values of wₜ^{T}, Bₜ, Lₜ, or Rₜ, for example by testing values and checking to see if known data can be satisfied by the test values using a linear programming feasibility method.

It may be appreciated that FIGS. 2, 3, and 4 each provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a data set;
partitioning the data set into two or more clusters;
creating two or more disjoint polytopic regions in a multi-dimensional space, wherein a cluster from the two or more disjoint polytopic regions corresponds to a trust region from the two or more polytopic regions;
training a machine learning model based on the two or more disjoint polytopic regions; and
drawing a conclusion based on the trained machine learning model.

2. The method of claim 1, wherein at least one region from the two or more regions is a low-confidence region signifying lower confidence than the trust region, and wherein another region from the two or more disjoint polytopic regions corresponds to a region with no support, signifying lower confidence than the low-confidence region.

3. The method of claim 1, wherein the training of the machine learning model is performed using an integer linear programming method or a mixed-integer linear programming method.

4. The method of claim 3, wherein the partitioning and the creating are each also performed using the integer linear programming method or the mixed-integer linear programming method.

5. The method of claim 1, wherein the feature is a target feature, and wherein drawing a conclusion includes determining a projected value of the target feature with respect to a data point where the value of the target feature is unknown.

6. The method of claim 1, wherein a region from the two or more disjoint polytopic regions is formed by two or more hyperplanes.

7. The method of claim 6, wherein a hyperplane in the two or more hyperplanes is defined using a coefficient vector, and wherein the coefficient vector contains at least one nonzero integer coefficient and at least one coefficient equal to zero.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a data set;
partitioning the data set into two or more clusters;
creating two or more disjoint polytopic regions in a multi-dimensional space, wherein a cluster from the two or more disjoint polytopic regions corresponds to a trust region from the two or more polytopic regions;
training a machine learning model based on the two or more disjoint polytopic regions; and
drawing a conclusion based on the trained machine learning model.

9. The computer system of claim 8, wherein at least one region from the two or more regions is a low-confidence region signifying lower confidence than the trust region, and wherein another region from the two or more disjoint polytopic regions corresponds to a region with no support, signifying lower confidence than the low-confidence region.

10. The computer system of claim 8, wherein the training of the machine learning model is performed using an integer linear programming method or a mixed-integer linear programming method.

11. The computer system of claim 10, wherein the partitioning and the creating are each also performed using the integer linear programming method or the mixed-integer linear programming method.

12. The computer system of claim 8, wherein the feature is a target feature, and wherein drawing a conclusion includes determining a projected value of the target feature with respect to a data point where the value of the target feature is unknown.

13. The computer system of claim 8, wherein a region from the two or more disjoint polytopic regions is formed by two or more hyperplanes.

14. The computer system of claim 13, wherein a hyperplane in the two or more hyperplanes is defined using a coefficient vector, and wherein the coefficient vector contains at least one nonzero integer coefficient and at least one coefficient equal to zero.

15. A computer program product, the computer program product comprising:
one or more computer-readable tangible storage media and program instructions stored on at least one of the one or more tangible storage media, the program instructions executable by a processor capable of performing a method, the method comprising:
identifying a data set;
partitioning the data set into two or more clusters;
creating two or more disjoint polytopic regions in a multi-dimensional space, wherein a cluster from the two or more disjoint polytopic regions corresponds to a trust region from the two or more polytopic regions;
training a machine learning model based on the two or more disjoint polytopic regions; and
drawing a conclusion based on the trained machine learning model.

16. The computer program product of claim 15, wherein at least one region from the two or more regions is a low-confidence region signifying lower confidence than the trust region, and wherein another region from the two or more disjoint polytopic regions corresponds to a region with no support, signifying lower confidence than the low-confidence region.

17. The computer program product of claim 15, wherein the training of the machine learning model is performed using an integer linear programming method or a mixed-integer linear programming method.

18. The computer program product of claim 17, wherein the partitioning and the creating are each also performed using the integer linear programming method or the mixed-integer linear programming method.

19. The computer program product of claim 15, wherein the feature is a target feature, and wherein drawing a conclusion includes determining a projected value of the target feature with respect to a data point where the value of the target feature is unknown.

20. The computer program product of claim 15, wherein a region from the two or more disjoint polytopic regions is formed by two or more hyperplanes.
